(19) United States
(12) Patent Application Publication
(10) Pub. No.: US 2015/0184693 A1
(43) Pub. Date: Jul. 2, 2015

(54) BEARING DEVICE AND EXHAUST GAS TURBOCHARGER

(71) Applicant: IHI CHARGING SYSTEMS INTERNATIONAL GMBH, Heidelberg (DE)

(72) Inventor: Bernhardt LUEDDECKE, Grossniedesheim (DE)

(21) Appl. No.: 14/658,181

(22) Filed: Mar. 14, 2015

Related U.S. Application Data
(63) Continuation-in-part of application No. PCT/EP2013/002707, filed on Sep. 10, 2013.

(30) Foreign Application Priority Data
Sep. 24, 2012 (DE) 102012108973.6

(51) Int. Cl. F16C 33/10; F16C 35/02

(52) U.S. Cl. CPC F16C 33/1045; F16C 35/02

(57) ABSTRACT

In a bearing device with a first bearing body (9) having a first mounting opening (10) accommodating a first rotation body (8) with a first gap (12) formed between an in wall (14) of the first bearing body (9) and an outer surface (13) of the first rotation body (8), a lubricant duct (11) is provided in the first bearing body (9), so as to form communication path to the first mounting opening (10) by way of an end area of the lubricant duct (11) oriented so as to impart a circumferential velocity component to the lubricant flow into the first gap (12) so as to impart a circumferential velocity component to the lubricant flow into the gap (12).

This is a Continuation-In-Part application of pending international application PCT/EP2013/002707 filed 2013 Sep. 10 and claiming the priority of German application 10 2012 108 975.6 filed 2012 Sep. 24.

### BACKGROUND OF THE INVENTION

The invention relates to a bearing device with a bearing housing having a support opening accommodating a first rotation body and a lubricant supply duct extending through the bearing body tangentially to the rotation body so as to impart a circumferential velocity component to the lubricant entering the space between the bearing housing and the rotation body and also to an exhaust gas turbocharger.

Bearing devices are used for supporting rotatable components, generally so-called shafts. These are basically classified into so-called friction bearings and anti-friction bearings. Anti-friction bearings are fixedly connected with the rotatable component, that is, the shaft or, a rotation body, by means of a so-called inner ring, wherein a so-called outer ring is fixedly connected to a housing in which the shaft is supported by means of rolling elements, e. g. balls or rollers which are positioned between the inner ring and the outer ring.

Friction bearings, on the other hand, principally are of a considerably simpler design. The shaft itself is rotatably accommodated in a bearing body, generally a bush or hollow cylinder, whose diameter and length depend on a body which is rotated by the shaft and thus on the forces generated by said body. This means, a gap which is more or less large, is formed between the shaft and an inner wall of the bearing body. In order to avoid friction between the inner wall of the bearing body and an outer surface of the shaft during operation, this gap is at least partially filled with a lubricant. The bearing body itself is accommodated in the housing with a mounting opening for the bearing body or the bearing body is formed by the housing which has a bearing portion.

A variant of the plain friction bearing is a so-called floating bush bearing. Here, the bearing body itself is movably supported in the housing and is therefore also rotatable. This means for a floating bush bearing that the shaft and the bearing body each are rotatably arranged in the housing. In order to allow the lubricant to enter the gap between the outer surface of the shaft and an inner wall of the bearing body, e. g. bearing body openings are provided which extend through the bearing body. The floating bush bearings are classified into so-called “semi-floating” bearings and “full-floating” bearings. The “semi-floating” bearing comprises a first rotation body in the first bearing body, with a second rotation body, generally a shaft, being rotatably positioned in the second bearing body. However, the first rotation body is fixed in the “semi-floating” bearing, though movability is possible but rotation is inhibited, This is the difference between the “full-floating” bearing in which the first rotation body is accommodated rotatably in the first bearing body.

A floating bush bearing is used in particular in mechanical engineering for high-speed shafts because one advantage of this bearing is that negative consequences caused by lubricants of possibly varying consistencies can be reduced. By way of example, the lubricant may generate lubricant whirls due to high speeds and high temperatures, which is also referred to as oil whirls. One consequence of an oil whirl is an instable bearing behavior which is caused by an irregularly build-up and break-down of the lubricant film thickness. The oil whirl alone would not be problematic but a so-called lock-on of this oil whirl, which is referred to as oil whip, is. This lock-on occurs with a coincidence of an oil whirl frequency and a mechanical natural frequency. These effects, both the oil whirl effect and in particular the oil whip effect, unexpectedly lead to contact friction with potential irreparable damage of the bearing apparatus. Because in operation, the oil whirl effect takes place before the oil whip effect, only the oil whirl effect will be discussed in the following.

An exemplary embodiment for reducing the so-called oil whirl effect may be taken from unexamined laid-open patent application DE 10 2008 000 853 A1. Here, grooves are formed in the inner wall of the bearing body, which are to provide for a lubricant flow direction of the lubricant opposite to the direction of rotation of the shaft, which may cause an interruption of the oil whirl effect and of the resulting lubricant whirl, respectively. However, with the disclosed subject matter this is only possible in the gap between the outer surface of the shaft and the inner wall of the bearing body. Further, the manufacture of a corresponding bearing body which comprises grooves in its inner wall, in particular of small bearing bodies as they are currently needed in the exhaust gas turbocharger manufacture due to reduced combustion engine dimensions, is complicated and expensive because special tools are required for forming the grooves.

It Is the principal object of the invention to provide a bearing device which achieves a reduction of the oil whirl effect by means of simple measures. It is another object of the invention to provide an exhaust gas turbocharger with a significantly improved efficiency by the use of this bearing device.

### SUMMARY OF THE INVENTION

In a bearing device with a first bearing body having a first mounting opening accommodating a first rotation body with a first gap formed between an inner wail of the first bearing body and an outer surface of the first rotation body, a lubricant duct is provided in the first bearing body, so as to form communication connection with the first mounting opening by way of an end area of the lubricant duct oriented so as to impart a circumferential velocity component to the lubricant flow into the first gap.

According to the invention, the lubricant duct is oriented so as to impart a circumferential velocity component to a lubricant flow of the lubricant for specifying the direction of a velocity resultant of the lubricant flow. Due to the fact that a circumferential velocity component is imparted to the lubricant flow by means of the lubricant duct already upon the inflow of the lubricant into the first mounting opening, the flow direction of the lubricant is already determined upon its inflow into the first mounting opening. Generally, a lubricant duct has a longitudinal duct axis which is positioned nearly orthogonally with respect to the longitudinal axis of the first mounting opening. Thus, the lubricant exhibits a velocity at an inflow into the first mounting opening which, apart from velocity losses resulting from static friction on duct walls of the lubricant duct, has a velocity flow direction along the longitudinal duct axis. In operation, the lubricant therefore also impinges more or less vertically onto the first rotation body and is distributed in the first mounting opening both opposite the direction of rotation and in the direction of rotation of the first rotation body. This means that portions of the lubricant, at least at the commencement of operation, exhibit opposite flow directions which collide at any part of the first mounting opening and therefore augment the oil whirl effect.

By means of the inventive bearing device, only one flow direction is imparted on the lubricant already upon its inflow into the first mounting opening. Thus, a collision of opposite-oriented lubricant portions is prevented. By the orientation of the lubricant duct it is possible to impart a flow direction on the lubricant, which is preferred for the relevant application of the bearing device, which has an effect on bearing friction, bearing characteristics such as e. g. stability, and bearing noise. This means that according to the orientation of the lubricant duct, a differential velocity between the first bearing body and the first rotation body may be influenced.

In an embodiment of the inventive bearing apparatus, the lubricant duct is formed to impart the circumferential velocity component in such a manner, that the velocity resultant is directed in the direction of rotation of the rotation body. The advantage of this embodiment is that a velocity resultant which has the same direction as the rotation body is imparted on the lubricant. This means that the identical orientation of the directions of the lubricant velocity and the direction of rotation of the first rotation body results in a reduction of the differential velocity, which again results in a reduction of bearing friction losses.

In an alternative embodiment of the inventive bearing device, the lubricant duct is formed to impart the circumferential velocity component in such a manner that the velocity resultant is directed opposite the direction of rotation of the rotation body. The advantage of this alternative embodiment is the flow direction opposite to that of the rotation body. If the rotation body causes an oil whirl effect, in particular at high speeds and at high operating temperatures, the oil whirl effect may be interrupted by means of the opposing lubricant portions.

This embodiment of the bearing device is to be employed in particular for very high-speed shafts, because the differential velocity is increased with an opposing orientation of the lubricant velocity so that the rotational speed of the rotation body is significantly reduced.

In another embodiment of the inventive bearing device, the longitudinal duct axis is oriented at least in an exit area of the duct in such a manner that a transverse axis of the first mounting opening which is aligned by means of a virtual Cartesian coordinate system relative to the longitudinal axis of the first mounting opening forms an angle with a virtual extension of the longitudinal duct axis. The value of the angle differs at least by 10° from 90°. This means in other words that for the generation of the circumferential velocity component the lubricant duct must be inclined at least in the area of the mouth relative to a transverse axis of a cross-sectional area of the first mounting opening. Further, it is not necessary that the longitudinal duct axis extends under said angle over the entire length of the lubricant duct, but for the generation of the desired circumferential velocity component it is sufficient that the relevant orientation is provided in the exit area of the duct.

In a particularly effective embodiment for the generation of the circumferential velocity component, the longitudinal duct axis is formed tangent-like to a first inner wall of the bearing body at least in an exit area in parallel displaced relationship.

In another embodiment, the rotation body has a second mounting opening for accommodating a shaft wherein a second gap is formed between a second inner wall of the rotation body and an outer surface of the shaft, with the second gap being configured to be supplied with lubricant by means of flow-through openings of the rotation body. This configuration allows a particularly reliable friction bearing in the sense of a floating friction bearing or floating bush bearing, respectively. Therefore, it is possible to eliminate the oil whirl effect which causes unsafe operating conditions such as e. g. instability or bearing noise already at the circumference of the rotating bearing body. Thus, a particularly smooth-running and low-noise bearing apparatus can be achieved.

Another embodiment contributes to an enhanced reliability and smooth running in that at least one of the flow-through openings is formed so as to impart an additional circumferential velocity component on the lubricant flow entering into the second mounting opening through the flow-through openings. The effects and advantages of a velocity component imparted on the lubricant need not be repeated here. Apart from the already mentioned advantages, another advantage is to be seen in that by means of the additional circumferential component the oil whirl effect also in the second mounting opening can, if not be eliminated, then at least be significantly reduced.

It was found to be particularly advantageous that an opening longitudinal axis of the flow-through opening in its virtual extension in the direction of an axis of rotation of the rotation body is formed so as to avoid a point of intersection with the axis of rotation for imparting the additional circumferential velocity component. In other words, the opening longitudinal axis is so oriented that a virtual extension of the opening longitudinal axis has no point of intersection with the axis of rotation, contrary to the state of the art. Due to the orientation of the opening longitudinal axis, it is therefore possible to impart an additional circumferential velocity component on the lubricant entering the second mounting opening through the flow-through opening. Depending on the application range of the bearing apparatus, this may either be in the direction of rotation of the shaft or opposite the direction of rotation of the shaft.

In a particularly advantageous embodiment, a second bearing body corresponds to the first rotation body, wherein the second bearing body is fixed in the first bearing body. This means in other words, that because of this fixed arrangement, the first rotation body is unable to rotate independently and serves as a support body for the second rotation body. In particular, this has the advantage that by means of this fixing, in addition to imparting the circumferential velocity component, a stabilization of the second bearing body is achieved so that bearing noise is, if not eliminated, then at least significantly reduced.

An inventive exhaust gas turbocharger, comprising a shaft with a bearing device for the rotatable support of the shaft includes a bearing device as described above. Thus, an exhaust gas turbocharger may be provided which contributes to the reduction in emissions in that friction losses of the exhaust gas turbocharger due to bearing friction losses are reduced. Thus, an exhaust gas turbocharger with a considerably improved exhaust gas turbocharger efficiency compared to the state of the art may be realized, which again results in an improvement of the overall efficiency of a combustion engine-exhaust gas turbocharger combination. With an increase in the overall efficiency, a reduction of the fuel quantity with constant power of the combustion engine is possible, which may lead to a reduction of the exhaust gas emissions. Another advantage is a reduction of noise emissions of the exhaust gas turbocharger due to a bearing apparatus with considerably better smooth-running properties.

The invention as well as advantages and suitable embodiments thereof will become more readily apparent from the following description of the invention with reference to the accompanying drawings.

### BRIEF DESCRIPTION OF THE DRAWINGS

FIG. 1 shows a sectional view of a bearing apparatus according to the state of the art,

FIG. 2 shows a sectional view of an inventive bearing apparatus in a firs exemplary embodiment,

FIG. 3 shows a sectional view of an inventive bearing apparatus in a second exemplary embodiment,

FIG. 4 shows a sectional view of an inventive bearing apparatus in a third exemplary embodiment,

FIG. 5 shows a sectional view of an inventive bearing apparatus in a fourth exemplary embodiment,

FIG. 6 shows a sectional view of a first rotation body of the bearing apparatus according to FIG. 1,

FIG. 7 shows a sectional view of a first rotation body of the bearing apparatus according to FIG. 2 in a first variant, and

FIG. 8 shows a sectional view of a first rotation body of he bearing apparatus according to FIG. 2 in a second variant.

### DESCRIPTION OF PARTICULAR EMBODIMENTS

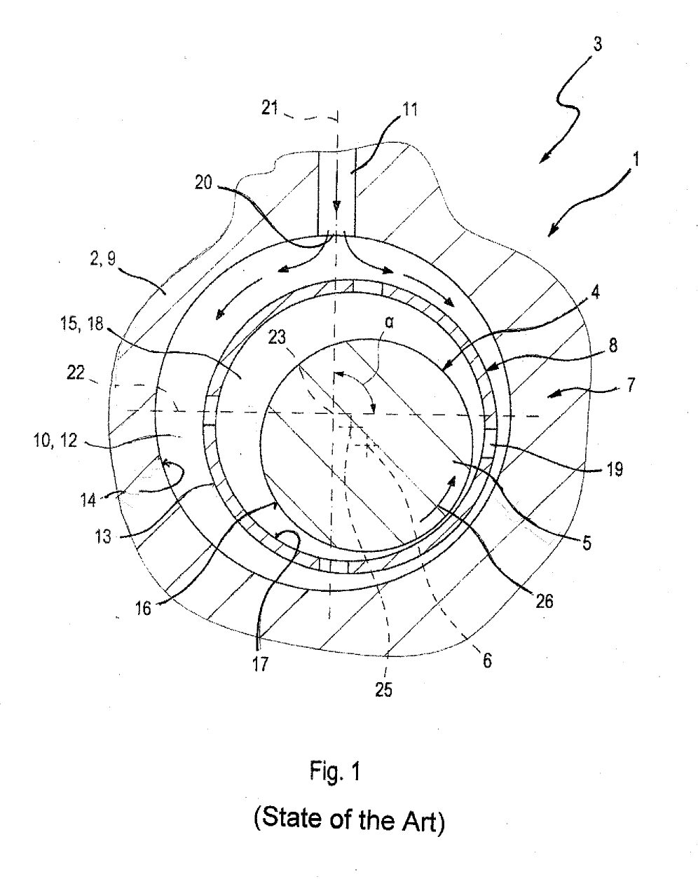

FIG. 1 shows a bearing apparatus 1 according to the state including the art of a bearing portion 2 of an exhaust gas turbocharger 3. The exhaust gas turbocharger 3 comprises a rotating assembly 4 which includes a compressor wheel (not shown in detail) for the intake and compression of combustion air, a turbine wheel (not shown in detail) for the expansion of exhaust gas in a combustion engine which is connected with the exhaust gas turbocharger as well as a shaft 5 with an axis of rotation 6, which non-rotatably connects the compressor wheel with the turbine wheel. The shaft 5 is rotatably supported in the bearing portion 2 of the exhaust gas turbocharger 3. In the following, the shaft 5 will be referred to as second rotation body 5.

During operation of the combustion engine, the turbine wheel is brought into a rotating motion, while the compressor wheel and the second rotation body 5 are also brought into rotation by means of the second rotation body 5 by which the compressor wheel is connected to the turbine wheel for rotation therewith.

The bearing apparatus 1 comprises a radial bearing 7, wherein a first rotation body 8 is movably accommodated in a first bearing body 9 of the bearing apparatus 1 in a mounting opening 10 of the first bearing body 9. The first bearing body 9 is formed in the bearing portion 2. The bearing portion 2 also comprises a lubricant duct 11 by means of which lubricant may be introduced into the mounting opening 10.

A variable first gap 12 is formed between the first bearing body 9 and the first rotation body 8, in which the first rotation body 8 is rotatably accommodated, wherein the lubricant which enters the first mounting opening 10 by way of the lubricant duct 11 via a flow-through exit area 20 connecting the lubricant duct 11 with the mounting opening 10 provides for a reduction of friction between a first outer surface 13 of the first rotation body 8 and a first inner surface 14 of the mounting opening 10.

In this example of the state of the art, the second rotation body 5 is also rotatably accommodated in the sleeve-shaped first rotation body 8 which comprises a second mounting opening 18 so that during operation of the exhaust gas turbocharger 3 both the second rotation body 5 and the first rotation body 8 perform a rotating motion. Between the second rotation body 5 and the first rotation body 8 a variable second gap 15 is provided. In order to reduce friction during operation of the exhaust gas turbocharger 2 between a second outer surface 16 of the second rotation body 5 and a second inner surface 17 of the first rotation body 8, the second gap 15 can be filled with lubricant from the first gap 12 by way of flow-through openings 19 formed in the first rotation body 8.

According to this example, the bearing apparatus 1 is formed as a floating bush bearing, with this bearing apparatus being preferably employed in the exhaust gas turbocharger engineering.

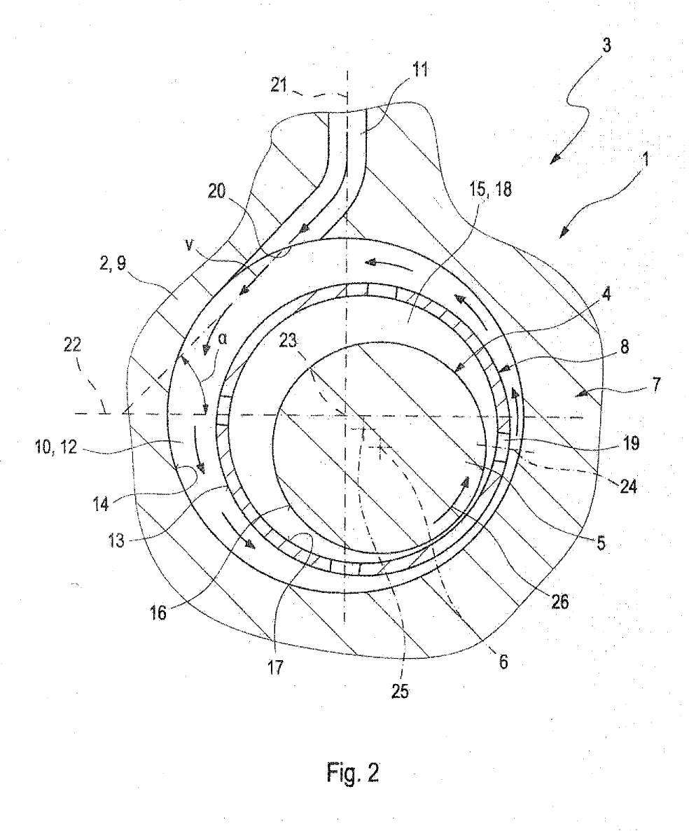

An inventive bearing apparatus 1 is constructed according to FIG. 2. The lubricant duct 11 is formed so as to impart a circumferential velocity component to the flow of the lubricant for specifying the direction of a velocity resultant v of the lubricant flow. The circumferential velocity component is designed such, that the velocity resultant v is directed in the direction of rotation according to the arrow 26 of the first rotation body 8.

A longitudinal duct axis 21 of the lubricant duct 11 is oriented in the exit area 20 thereof in such a manner that a transverse axis 22 of the first mounting opening 10 which is formed by means of a virtual Cartesian coordinate system aligned relative to a longitudinal axis 23 of the first mounting opening 10 with a virtual extension of the longitudinal duct axis 21 forms an angle α. The angle α may have a value which differs by approx. −10° to −45° from a standard value of 90°. Here, the angle α is always the angle formed between the transverse axis 22 and the extension of the longitudinal duct axis 21, which faces the longitudinal axis 23.

The longitudinal duct axis 21 is formed in the exit area 20 displaced in parallel relationship as tangent to the first inner wall 14 of the first bearing body 9. In an exemplary embodiment (not shown in detail), the lubricant duct 11 has the orientation of the longitudinal duct axis 21 which is formed in the exit area 20 over the entire duct length.

In another exemplary embodiment, four flow-through openings 19 which are arranged equally spaced over the circumference of the first rotation body 8 are formed which impart an additional circumferential velocity component to the lubricant flow. The first rotation body 8 could also comprise three or six flow-through openings 19 or any number of flow-through openings 19, respectively.

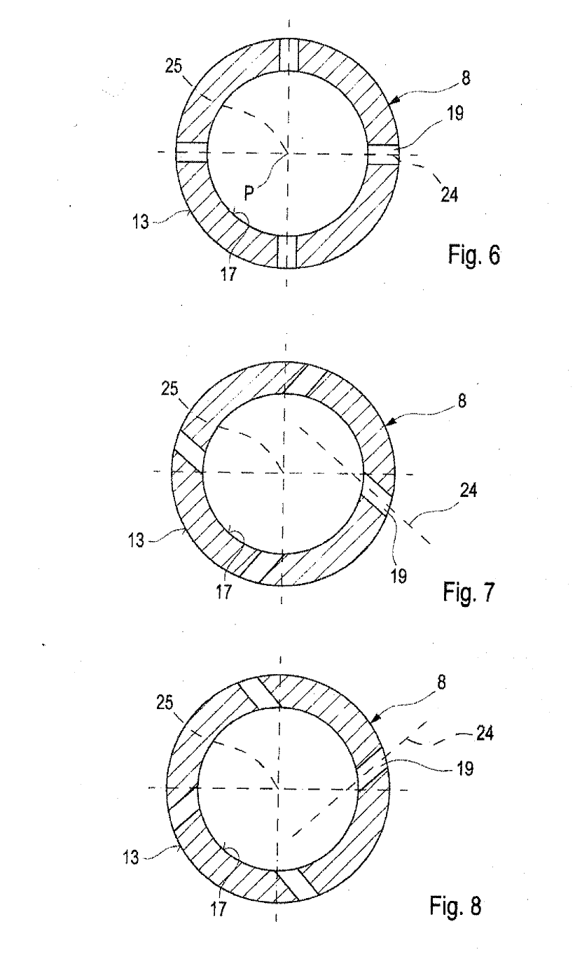

For imparting the additional circumferential velocity component on the lubricant flow flowing into the second mounting opening 18, an opening longitudinal axis 24 of the flow-through opening 19 is formed so as to avoid a point of intersection P with the axis of rotation 25 in its virtual extension in the direction of the axis of rotation 25. This means in other words that the opening longitudinal axis 24 and the axis of rotation 25 have no common point of intersection P. If they had a common point of intersection P, the opening longitudinal axis 24 in its virtual extension would intersect the axis of rotation 25, as is shown in FIG. 6. This arrangement has no advantage in respect to the so-called oil swirl effect.

For imparting an additional circumferential velocity component on the lubricant flow, exemplary embodiments of the first rotation body 8 according to FIGS. 7 and 8 are to be formed. An orientation of the opening longitudinal axis 24 is to be determined according to the application of the first rotation body 8.

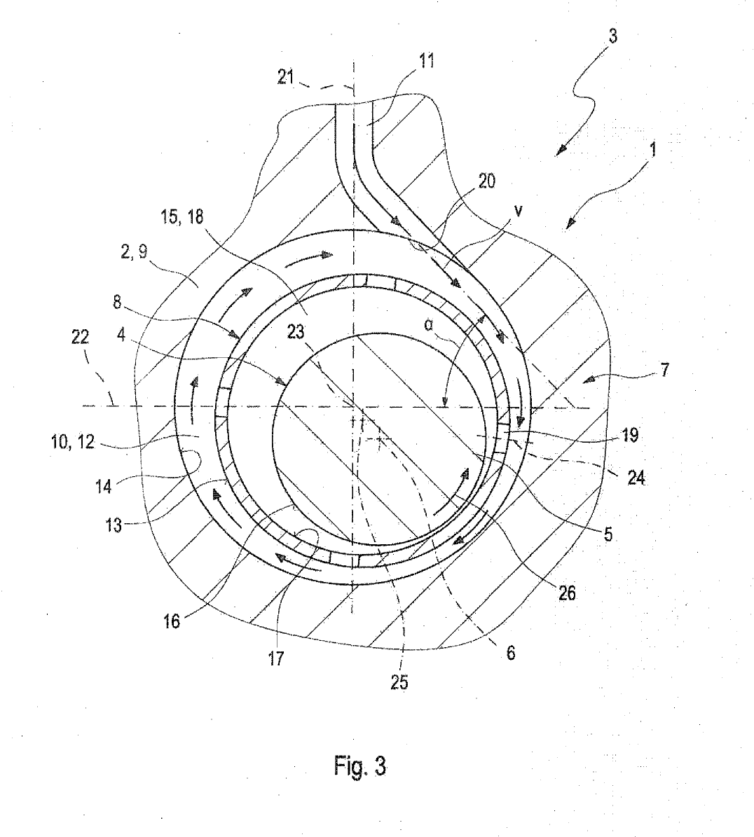

An inventive bearing apparatus of a second exemplary embodiment is formed according to FIG. 3. The lubricant duct 11 is arranged in such a manner that the circumferential velocity component generating the velocity resultant v is directed opposite the direction of rotation 26 of the rotation body 8.

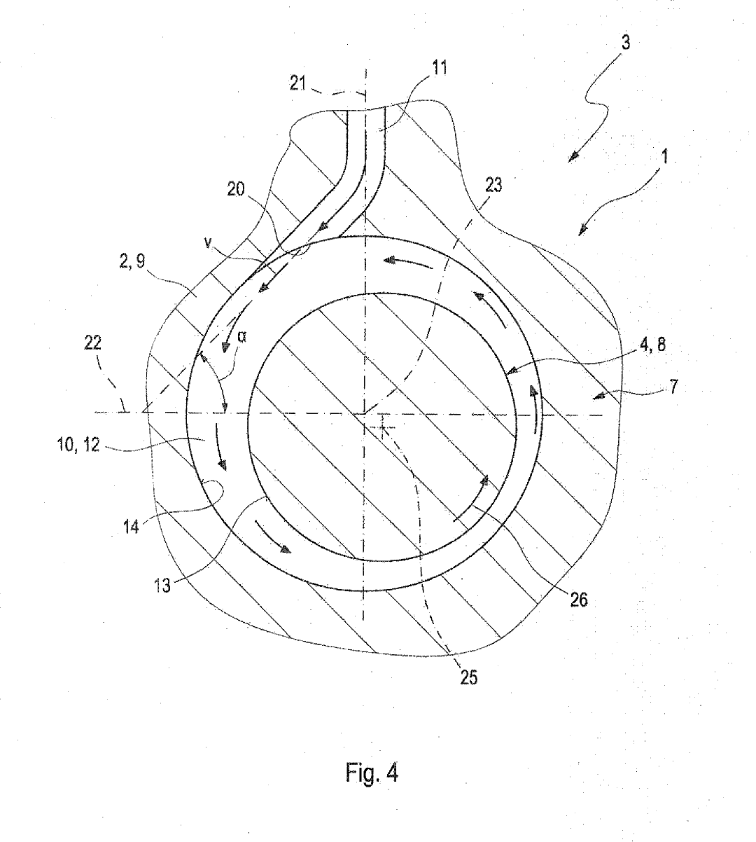

A third exemplary embodiment of the inventive bearing apparatus 1 is shown in FIG. 4. The first rotation body 8 is rotatably accommodated in the first bearing body 9 which is formed by the bearing portion 2. In this exemplary embodiment, the first rotation body 8 is formed as a non-rotatable connection between the turbine wheel and the compressor wheel. The first bearing body 9 could also be formed sleeve-shaped and fixed in the first mounting opening 10 without the formation of a first gap 12.

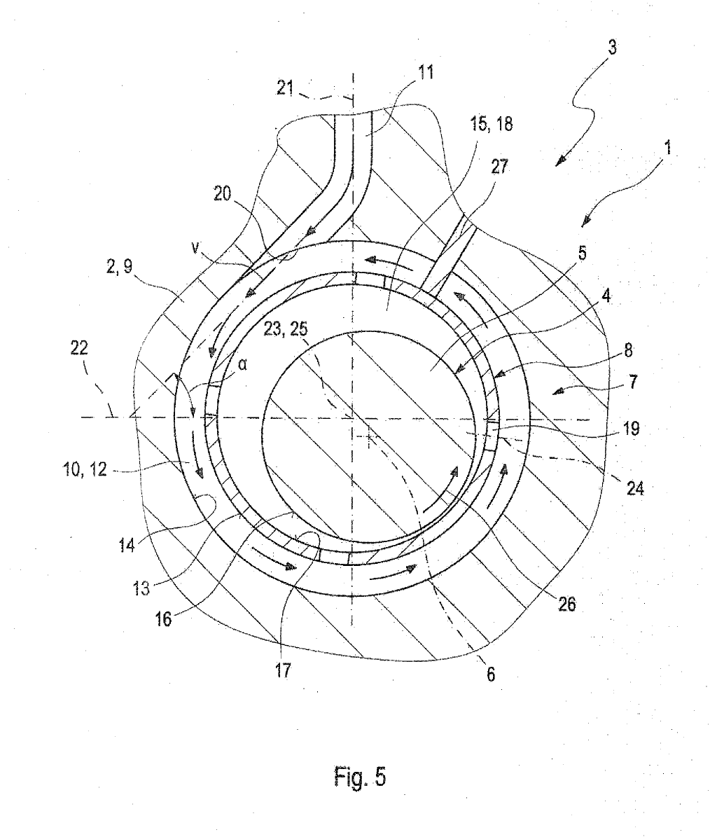

Another exemplary embodiment of the inventive bearing apparatus 1 is formed according to FIG. 5. The first rotation body 8 is fixed in the first bearing body 9 by means of a fastening means 27. This means that a rotation motion is inhibited. However, the first gap 12 is still formed between the first outer surface 13 and the first inner wall 14, which is invariable in this exemplary embodiment.

A standard method for manufacturing a lubricant duct 11 according to the state of the art is a machining process, e. g. drilling. In a most simple manner, the inventive bearing apparatus 1 could be manufactured such that an additional lubricant duct is cut into the bearing portion 2 transversely to the lubricant duct and intersecting same in addition to the already existing according to the state of the art, so that in the exit area 20 the additional lubricant duct is formed tangent-like to the first inner wall 14 of the bearing body 9. Upstream of the formed cut surface between the lubricant duct according to the state of the art and the additional lubricant duct, the additional lubricant duct is to be sealed, while downstream of the cut surface, the lubricant duct according to the state of the art is to be sealed so that the lubricant duct 21 is formed according to the inventive bearing apparatus 1.

Another method for manufacturing the inventive bearing apparatus 1 may be performed e. g. by providing a so-called insert. This means that a portion of the lubricant duct 11, which is formed in the exit area 20 and which in at least the area where the longitudinal duct axis 21 is formed in a virtual parallel shift tangent-like to the first inner wall 14 of the first bearing body 9 is a component which is independently manufactured from the bearing portion 2 and which for finishing the bearing portion 2 may be inserted into bearing portion 2. Tightness between the insert and the bearing body 9 may be achieved e. g. by means of a press fit.

Furthermore, the lubricant duct 11 could be formed into the bearing portion 2 and/or into the bearing body 9 by means of an electrochemical method or by means of an electric discharge machining method.

What is claimed is:

1. A bearing device comprising a first bearing body (9) having a first mounting opening (10) accommodating a first rotation body (8) with a first axis of rotation (25), so that a first annular gap (12) is formed between an inner wall (14) of the first bearing body (9) and an outer surface (13) of the first rotation body (8), a lubricant duct (11) with a longitudinal duct axis (21) formed in the first bearing body (9), so as to provide for a communication connection between the first mounting opening (10) via an exit end (20) of the lubricant duct (11) to the first mounting opening (10) for supplying lubricant to the annular first gap (12) via the lubricant duct (11), the exit end of the lubricant duct (11) being oriented tangentially to the annular gap (12) so as to impart a circumferential velocity component to the flaw (v) of the lubricant into the annular gap (12).

2. The bearing device according to claim 1, wherein the lubricant duct (11) is formed so as to impart the circumferential velocity component in such a manner that the velocity resultant (v) is directed in the direction of rotation of the first rotation body (8).

3. ring apparatus according to claim 1, wherein the lubricant duct (11) is formed so as to impart the circumferential velocity component in such a manner that the velocity resultant (v) is directed in a direction opposite the direction of rotation of the first rotation body (8).

4. The bearing device according to claim 1, wherein the longitudinal duct axis (21) at least the end an area (20) of the duct (11) is oriented in such a manner that a transverse axis (22) of the first mounting opening (10) which is aligned by means of a virtual Cartesian coordinate system relative to a longitudinal axis (23) of the first mounting opening (10) forms an angle α with a virtual extension of the longitudinal duct axis (21) in the end area (20), the value of which differ by at least 10° from a standard value of 90°.

5. ring device according to claim 4, wherein the longitudinal duct axis (21) is formed tangent-like at least in the end area (20) in a virtual parallel shift to an inner wall (14) of the first bearing body (9).

6. The bearing device according to claim 1, wherein the first rotation body (8) comprises a second mounting opening (18) for accommodating a second rotation body (5), wherein a second gap (15) is formed between an inner wall (17) of the first rotation body (8) and an outer surface (16) of the second rotation body (5), and the first rotation body (8) has flow-through openings (19) for supplying lubricant to the second gap (15).

7. The bearing device according to claim 6, wherein at least one of the flow-through openings (19) is oriented so as to impart an additional circumferential velocity component on the lubricant flow passing through the flow-through openings (19) and entering the second mounting opening (18).

8. The bearing device according to claim 7, wherein the flow-through opening (19) is formed so that a longitudinal axis (24) of the flow-through opening (19) in its virtual extension in the direction toward the axis of rotation (25) is spaced from the axis of rotation (25).

9. The bearing apparatus according to claim 6, wherein a second bearing body corresponding to the first rotation body (8) is provided which second bearing body is fixed in the first bearing body (9).

10. An exhaust gas turbocharger, comprising a shaft with a bearing device for supporting a rotatable support of the shaft (5), the bearing device being in the form as defined in claim 1.
